(19) United States
(12) Patent Application Publication
(10) Pub. No.: US 2024/0163399 A1
(43) Pub. Date: May 16, 2024

(54) SELECTIVE PRIVACY EXPOSURE FOR SMART RECORDING AND PLAYBACK OF VIRTUAL EVENTS

(71) Applicant: INTERNATIONAL BUSINESS MACHINES CORPORATION, ARMONK, NY (US)

(72) Inventors: Priyansh Jaiswal, Boca Raton, FL (US); Peeyush Jaiswal, Boca Raton, FL (US); Paul Llamas Virgen, Guadalajara (MX); Jonathan D. Dunne, Dungarvan (IE)

(21) Appl. No.: 18/055,863

(22) Filed: Nov. 16, 2022

(51) Int. Cl. H04N 7/15; H04L 9/32; H04L 12/18

(52) U.S. Cl. CPC H04N 7/152; H04L 9/3213; H04L 9/3226; H04L 12/1822; H04L 12/1831; H04N 7/155

(57) ABSTRACT

According to one embodiment, a method, computer system, and computer program product for selective conference recording is provided. The embodiment may include, in response to an initiation of a recording of a web conference, receiving a recording authorization selection and a recording access permission selection from each participant within a plurality of participants to the web conference. The embodiment may also include writing the recording authorization selection and the recording access permission selection to a corresponding TCP header for each participant. The embodiment may further include recording a stream of the web conference for each participant based on the recording authorization selection. The embodiment may also include, in response to the recording ending, encrypting the stream for each participant based on the recording access permission selection. The embodiment may also include generating an enriched recording of the web conference based on the encrypted streams.

### BACKGROUND

The present invention relates generally to the field of computing, and more particularly to web conferencing.

Web conferencing, including but not limited to audio conferencing and video conferencing, may relate to any communication between two or more individuals over a network, such as the Internet, where the participating members utilize audio and/or video streams. Web conferencing allows for a dynamic interface between users in separate locations to efficiently communicate as if they were in person by allowing face-to-face interactions and the sharing of files between participating users. Popular web conferencing applications include Zoom® (Zoom and all Zoom-based trademarks and logos are trademarks or registered trademarks of Zoom Video Communications Inc. and/or its affiliates), Webex® (Webex and all Webex-based trademarks and logos are trademarks or registered trademarks of Webex Communications, Inc. and/or its affiliates), GoToMeeting® (GoToMeeting and all GoToMeeting-based trademarks and logos are trademarks or registered trademarks of Citrix Online, LLC. and/or its affiliates), and FaceTime® (Facetime and all Facetime-based trademarks and logos are trademarks or registered trademarks of Apple Inc. and/or its affiliates) among others. Many web conferencing application allow uses to record either, or both, audio and video streams being presented during a session for subsequent sharing and playback.

### SUMMARY

According to one embodiment, a method, computer system, and computer program product for selective conference recording is provided. The embodiment may include, in response to an initiation of a recording of a web conference, receiving a recording authorization selection and a recording access permission selection from each participant within a plurality of participants to the web conference. The embodiment may also include writing the recording authorization selection and the recording access permission selection to a corresponding TCP header for each participant. The embodiment may further include recording a stream of the web conference for each participant based on the recording authorization selection. The embodiment may also include, in response to the recording ending, encrypting the stream for each participant based on the recording access permission selection. The embodiment may also include generating an enriched recording of the web conference based on the encrypted streams.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a selective conference recording process according to at least one embodiment.

FIG. 3 is a block diagram of an adjusted Transmission Control Protocol (TCP) header according to at least one embodiment.

FIG. 4 is a block diagram of permissions modification of a web conference recording according to at least one embodiment.

FIG. 5 is a block diagram of a selective conference recording process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to web conferencing. The following described exemplary embodiments provide a system, method, and program product to, among other things, facilitate selective recording of individuals during a web conference. Therefore, the present embodiment has the capacity to improve the technical field of web conferencing by allowing a lightweight, modular, and containerized recording solution through a Transmission Control Protocol (TCP) header.

As previously described, web conferencing, including but not limited to audio conferencing and video conferencing, may relate to any communication between two or more individuals over a network, such as the Internet, where the participating members utilize audio and/or video streams. Web conferencing allows for a dynamic interface between users in separate locations to efficiently communicate as if they were in person by allowing face-to-face interactions and the sharing of files between participating users. Popular web conferencing applications include Zoom® (Zoom and all Zoom-based trademarks and logos are trademarks or registered trademarks of Zoom Video Communications Inc. and/or its affiliates), Webex® (Webex and all Webex-based trademarks and logos are trademarks or registered trademarks of Webex Communications, Inc. and/or its affiliates), GoToMeeting® (GoToMeeting and all GoToMeeting-based trademarks and logos are trademarks or registered trademarks of Citrix Online, LLC. and/or its affiliates), and FaceTime® (Facetime and all Facetime-based trademarks and logos are trademarks or registered trademarks of Apple Inc. and/or its affiliates) among others. Many web conferencing application allow uses to record either, or both, audio and video streams being presented during a session for subsequent sharing and playback.

Web conferencing is an emergent technology becoming more vital to the everyday world. Due to various reasons, a recording of a web conference, video or otherwise, may be required and/or helpful for future reference to information discussed and/or presented in the web conference. However, situations arise were some confidential or privileged information presented in a web conference is leaked to non-participants of the web conference not privy to such information or a participant does not wish to be recorded for privacy or personal reason. While solutions exist that allow screen regions to be hidden or blurred, these solutions are cumbersome and don't address the right of the individual to be forgotten as apart of web conference group recording. As such, it may be advantageous to, among other things, utilize a lightweight selective recording mechanism as a web conferencing solution that provides participants the ability to configure recording and permissions.

According to one embodiment, a selective conference recording program may present a dialog for each web conference participant to complete when a conference host initiates a recording. The dialog may allow each participant to select options related to recording permissions by the selective conference recording program, which may include, but are not limited to, voice and video recording permissions. The selective conference recording program may dynamically monitor the speaking participant during the web conference in real time as the web conference is recorded and tag when specific participants speak, present or otherwise participate in the web conference. At the conclusion of the web conference, the selective conference recording program may modify the recording based on the selected user dialog options. For example, if a user selected to not have their participation recorded, the selective conference recording program may modify the recording to omit any instances when the user interacted (e.g., spoke, shared a screen, or typed in a chat) during the web conference. Upon generating the modified, or enriched, recording, the selective conference recording program may transmit the recording, or otherwise make the recording available, to the participants and any designated non-participants.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

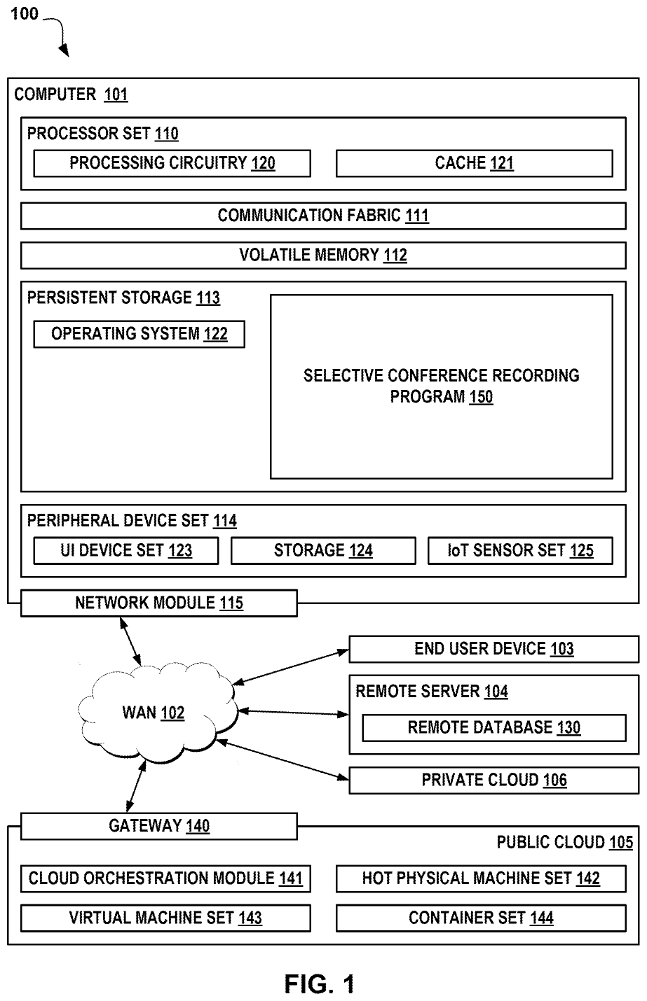

Referring now to FIG. 1, computing environment 100 contains an example of an environment for the execution of at least some of the computer code involved in performing the inventive methods, such as selective conference recording program 150. In addition to selective conference recording program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and selective conference recording program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in selective conference recording program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in selective conference recording program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

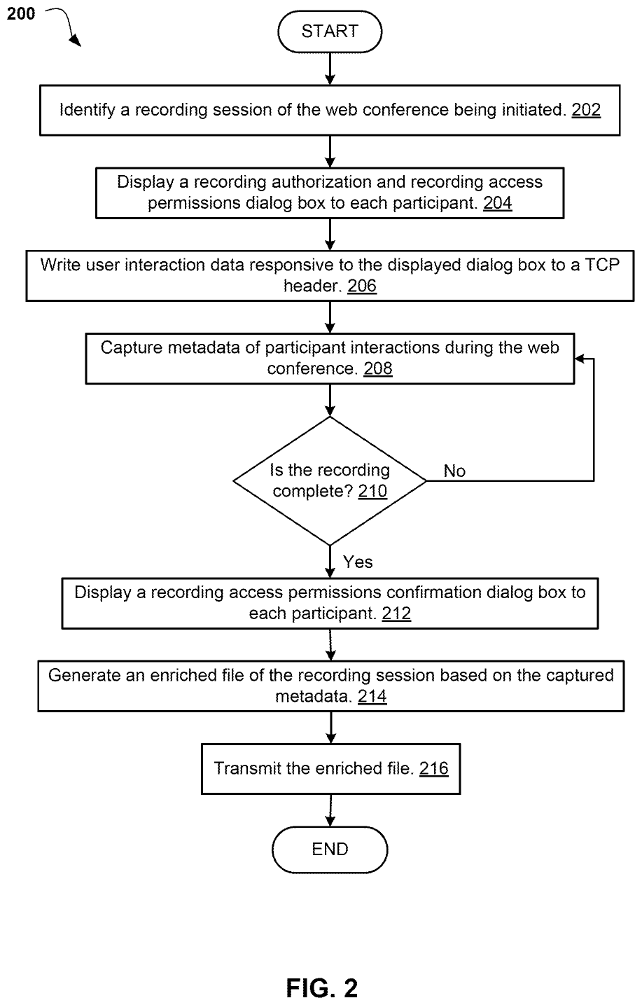

According to at least one embodiment, the selective conference recording program 150 may, upon identifying the initiation of a web conference recording session, present a dialog box to web conference participants as to recording authorization for each participant's audio and or video transmitted to the web conference during the recording as well as security permissions (e.g., password protection) for their specific recording thereby allowing each participant to control any individuals (participants or non-participants) from accessing their specific segment(s) of the recording content. The selective conference recording program 150 may set a Boolean flag in the TCP header to indicate each participant's selections. Upon commencement of the recording, the selective conference recording program 150 may capture metadata of participant interactions and generate a recording tagged with the metadata, such as a timestamp and current speaker. The selective conference recording program 150 may further generate an enriched recording file that takes into account each user selection from the dialog box presented at the initiation of recording. The enriched file created by the selective conference recording program 150 may remove audio and/or video feeds from specific participants based on each participant's recording authorization. Furthermore, notwithstanding depiction in computer 101, the selective conference recording program 150 may be stored in and/or executed by, individually or in any combination, end user device 103, remote server 104, public cloud 105, and private cloud 106. It may be appreciated that the examples described below are not intended to be limiting, and that in embodiments of the present invention the parameters used in the examples may be different. The selective conference recording method is explained in more detail below with respect to FIGS. 2-5.

Referring now to FIG. 2, an operational flowchart for a selective conference recording process 200 is depicted according to at least one embodiment. At 202, the selective conference recording program 150 identifies a recording session of the web conference being initiated. During the commencement or conduction of a web conference, a host may determine that the web conference should be recorded to preserve content presented either for participants to refresh recollection as to the content of the web conference or non-participants to be able to engage with the material discussed. As such, the selective conference recording program 150 may identify an instance of a host participant selecting a recording option within a web conferencing application. As previously discussed, a web conferencing application may be any software program capable of connecting two or more users, through user devices (e.g., computer 101 or EUD 103), that enables the transmission of data, such as audio, video, and text, between the users in a collaborative space over WAN 102.

Then, at 204, the selective conference recording program 150 displays a dialog box to each participant with recording authorization and access permissions options. Upon identifying the host user has initiated a recording, the selective conference recording program 150 may present a dialog box to each participant of the web conference on a graphical user interface (GUI) of the web conferencing software. The presented dialog box may include one or more recording options unique to each participant and access permissions for individuals authorized to access the segments of the recording in which the participant presents or speaks. The recording options may include, but are not limited to, authorization to capture audio, video, and text. The access permissions may include password protection or tokenization. Each participant may interact with the dialog box to indicate their selections as to the presented recording options. Interactions with the dialog box may include use of any peripheral device from peripheral device set 114. In one or more other embodiments, each user may preconfigure their selections for web conference recordings in a settings menu rather than through a dialog box presentation at the commencement of each individual recording instance. Furthermore, if a participant enters the web conference after recording has begun, the selective conference recording program 150 may prompt the participant with the recording authorization and access permissions dialog box when the user enters the web conference.

Next, at 206, the selective conference recording program 150 writes user interaction data responsive to the displayed dialog box to a TCP header. The user interaction data may relate to the recording authorization and recording access permissions selections described in step 204. The selective conference recording program 150 may receive each participant's recording authorization and recording access permissions selections, as presented in step 204, and store the participant-specific selections in the optional data of a TCP header as a Boolean flag. For example, if a participant authorizes recording of audio, the selective conference recording program 150 may set the Boolean flag as “true”. In another embodiment, if a participant does not want to require a password to be entered by an individual to access their segments of the recording, the selective conference recording program 150 may set the Boolean flag as “false”. The selective conference recording program 150 may initiate the recording once recording authorization and recording access permissions for each participant are received. For example, the selective conference recording program 150 may present authorization requests to each of three web conference participants requesting authorization to include each participant's audio, video, and chat inputs (e.g., text, images, emojis, GIFs, etc.) during a recorded web conference. In response, one user may authorize recording of all items, another user may deny recording of all items, and the final user may authorize recording of video and audio but not chat inputs.

When a participant opts out of recording audio during segments of the web conference in which that specific participant speaks, the selective conference recording program 150 may present the participant's audio to the other participants, however, no audio will be recorded. In such a situation, the selective conference recording program 150 may attenuate the recorded audio volume for the speaker's audio to −96 db, which may effectively record a blank sound to the recording. In at least one other embodiment, the selective conference recording program 150, rather than attenuating the volume of the speaker's audio to −96 db, may instruct an RTP stream to not transmit audio back to an AV multiplexing recording system. Additionally, when a participant opts out of recording their interactions through a negative recording authorization response, the selective conference recording program 150 may automatically deny recording access permissions for that individual since not recording for the participant will be available with which to encrypt.

In a situation where a participant opts to permit recording their audio, video, and/or chat interactions but elects to privacy protection through a password, the selective conference recording program 150 may still be heard or seen by all other participants in the web conference when the participant is speaking, presenting, or otherwise interacting during the web conference. However, the participant's audio, video, and/or chat interactions, when the selective conference recording program 150 is recording the audio, video, and/or chat interactions, the audio, video, and/or chat interactions may be in an encrypted state. Therefore, only individuals in possession of a password or token, in the case of encryption through tokenization, may view and/or see the participant's unencrypted segments. Any individual not in possession of the password or token may be presented with attenuated audio volume (e.g., −96 db) and/or a blank presentation screen.

Next, at 208, the selective conference recording program 150 captures metadata of participant interactions during the web conference. The selective conference recording program 150 may then commence recording of the web conference. The selective conference recording program 150 may capture various items of metadata during the recording, such as, but not limited to, timestamp information for each interaction, current speaking participant, target participant of the current speaking participant, gesture identification information (e.g., thumbs up and thumbs down), information regarding participants entering and exiting the web conference, and, if a poll was conducted during the web conference, polling information (e.g., results. Since one or more participants may not authorize recording of their interactions (i.e., audio, video, or chat), the selective conference recording program 150 may record the web conference according to each user's recording authorization as described in step 204. As such, the selective conference recording program 150 may identify, in real time, the current presenting participant and whether that participant has authorized recording of the current form of presentation. For example, if a participant is currently speaking, the selective conference recording program 150 may identify the current speaking participant through either voice recognition or audio input being received from an audio input device (e.g., a microphone) from the user computing device. If the current speaking participant has denied recording authorization for audio data, the selective conference recording program 150 may not record the audio stream presented to the web conference for the speaking participant upon determination that that participant has begun speaking. However, if the same participant authorized recording of video and/or chat interactions, the selective conference recording program 150 may record those interactions.

Then, at 210, the selective conference recording program 150 determines whether the recording is complete. The selective conference recording program 150 may determine the recording is complete when the participant, usually the host participant, interacts with a “stop recording” icon on the GUI of the web conferencing application or when the host participant ends the web conference. If the selective conference recording program 150 determines the recording is complete (step 210, “Yes” branch), then the selective conference recording process 200 may proceed to step 212 to display a recording access permissions confirmation dialog box to each participant. If the selective conference recording program 150 determines the recording is not complete (step 210, “No” branch), then the selective conference recording process 200 may return to step 208 to continue capturing metadata of participant interactions during the web conference.

Then, at 212, the selective conference recording program 150 displays a recording access permissions confirmation dialog box to each participant. At the conclusion of the web conference, the selective conference recording program 150 may display a recording access permissions confirmation dialog box in a similar manner previously described in step 204. The recording access permissions confirmation dialog box may be a dialog box presented to each participant of the web conference, at the conclusion of recording or at the conclusion of the web conference, that requests each participant to modify or confirm privacy permissions of individuals authorized to access the applicable sections of the web conference recording. For example, a participant may have indicated in the original recording access permissions selection in step 204 to not allow permissions, however, after speaking on matters that the participant wishes to be kept only to the web conference participants, the participant may modify the selection at the conclusion of the web conference to enable recording access permissions in the form of a password. In one or more other embodiments, each user may preconfigure their selections for recording access permissions in a settings menu rather than through a dialog box presentation at the conclusion of each individual recording instance.

In at least one other embodiment, the selective conference recording program 150 may display the recording access permissions dialog box to a participant leaving an ongoing web conference that is being recorded. For example, if a user must leave the web conference before the conclusion of the recording or the conclusion of the web conference itself, the selective conference recording program 150 may display the recording access permissions confirmation dialog box to the departing participant when the participant interacts with a “leave web conference” icon on a GUI of the web conferencing software.

Next, at 214, the selective conference recording program 150 generates an enriched file of the recording session based on the captured metadata. The selective conference recording program 150 may generate the enriched file of the recording session based on the recording access permissions indicated by each participant in steps 204 and 212. According to one embodiment, the selective conference recording program 150 may encrypt the recording through password protection or tokenization to allow only authorized users to access specific segments of the recording based on each individual's designated recording access permission. For example, if a user only allows access to their segments of the recording in which that user spoke, presented, or input into a chat window to only participants of the web conference, the selective conference recording program 150 may assign a tag and/or token to the identified segments of the recording associated with the user with the designation. As such, any non-participant accessing the recording may not be able to listen or view segments of the recording associated with the user since the encrypted segments are hidden from the unauthorized non-participant. Conversely, participants of the web conference, in this scenario, may be able to listen or observe the encrypted segments due to their possession of a decryption password or a token that enables decryption of the encrypted segments. The selective conference recording program 150 may utilize one of two approaches for encryption. In one or more other embodiments, the selective conference recording program 150 may allow a user to establish a password for accessing their corresponding recorded segments of the web conference. Under this encryption method, the selective conference recording program 150 may perform encryption as part of a two-way cipher. When the password is supplied, the selective conference recording program 150 may decrypt the recording. As a second approach, the selective conference recording program 150 may utilize segmentation, or tokenization. Based on distinct parts of the recording, the selective conference recording program 150 may issue a private key that could be associated with certain individuals (e.g., web conference participants) so decryption would only occur for those segments, or regions, when the private key is present on a device. For example, if the selective conference recording program 150 encrypted a specific participant's audio segments based on the permissions established by that participant, the selective conference recording program 150 may generate a private key when encrypting the audio segments and only individuals in possession of or listed in the private key, if the private key were an object containing metadata, may decrypt the audio segments using the selective conference recording program 150.

Then, at 216, the selective conference recording program 150 transmits an enriched file of the recording session based on the captured metadata. Upon creation of the modified recording, the selective conference recording program 150 may transmit, or otherwise make available for viewing or listening, the enriched file of the recording to the participants and any authorized non-participants. For example, the selective conference recording program 150 may email with the recording attached or with an accompanying link to a cloud-based version of the recording.

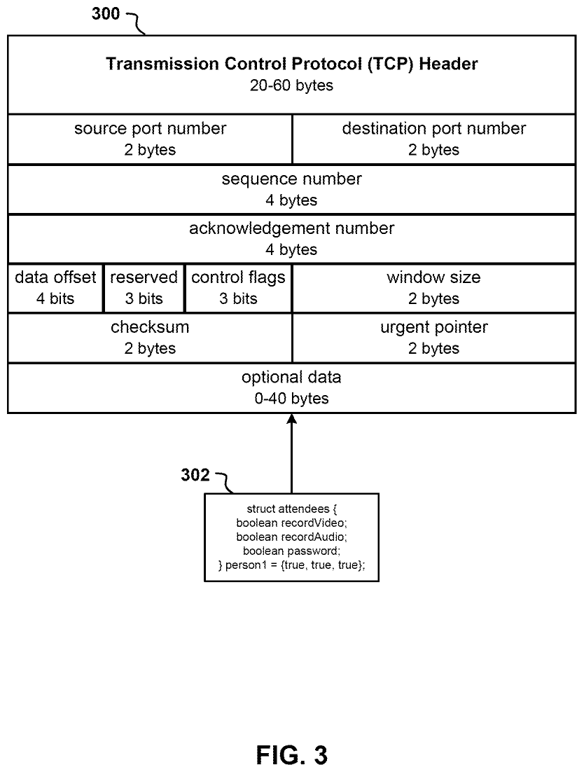

Referring now to FIG. 3, a block diagram of an adjusted Transmission Control Protocol (TCP) header 300 is depicted according to at least one embodiment. Typically, the TCP header 300 includes various items of information including source port number, destination port number, sequence number, acknowledgement number, data offset, a reserved field, control flags, window size values, the checksum, an urgent pointer, and an optional data field. The selective conference recording program 150 may utilize the optional data field to store the recording authorization and recording access permissions. For example, authorization and permissions information 302 illustrates optional information included in the TCP header 300 for a user that has opted-in to allowing recording of video and audio and a password to access the recorded segments of interactions in the web conference recording.

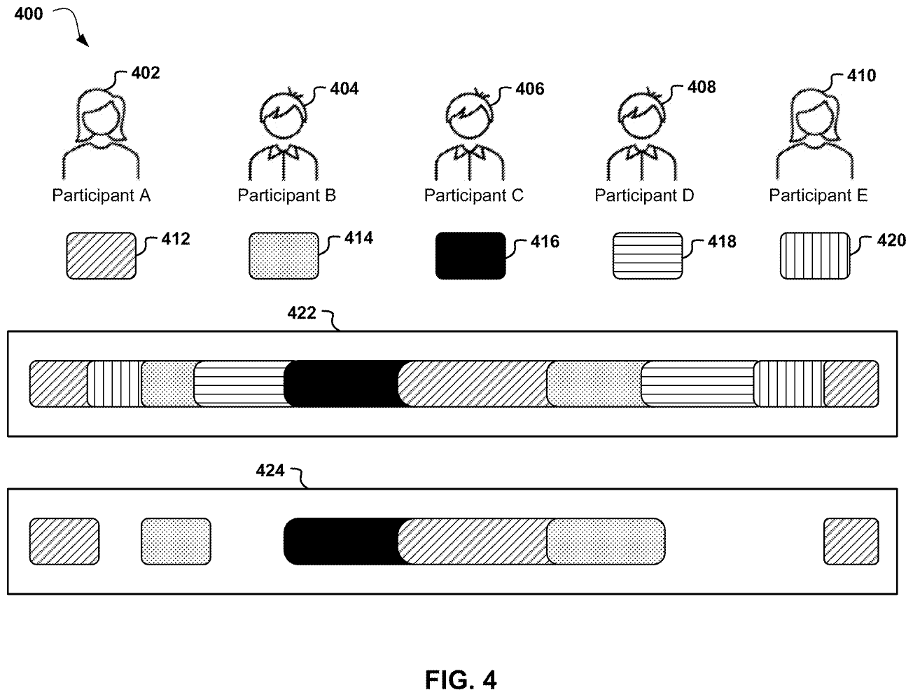

Referring now to FIG. 4, a permissions modification block diagram 400 of a web conference recording is depicted according to at least one embodiment. As described in step 214, once the selective conference recording program 150 receives each participant's recording access permission confirmation, the selective conference recording program 150 may generate an enriched file of the recording that omits any recording segments for individuals that either declined recording altogether or opted to only allow access to their recorded segments to specific individuals possessing a corresponding token or password. For example, a web conference conducted between five participants (i.e., Participants A-E 402-410) may be represented as a segmented recording 422 where each segment of the recording corresponds to audio, video, or chat inputs of each participant. Each segment of the segmented recording 422 may be referenced to each participant by a different fill (i.e., fills 412-420). For example, angled line fill 412 may correspond to Participant A 402.

In order to generate the enriched file, the selective conference recording program 150 may remove certain segments of segmented recording 422 to generate the enriched, segmented recording 424. The enriched segmented recording 424 may be a graphical representation of the enriched recording file should an individual not in possession of a corresponding token or password. The enriched, segmented recording 424 illustrates the removal of recorded segments of the web conference corresponding to participants that opted to specific recording access permissions. For example, vertical line fill 420 may correspond to Participant E 410 who opted in to recording access permissions requiring either a token or a password for specific individuals to access the segments of the enriched file recording. As such, the enriched, segmented recording 424 may depict the representation of the enriched file to an individual not in possession of the token or password corresponding to Participant E 410. When an individual not in possession of the token or password listens to a playback of the enriched file recording, the selective conference recording program 150 may playback no audio or video when the removed segment is encountered. In one or more embodiments, the selective conference recording program 150 may display an icon or dialog indicating that the individual is not privileged or permitted to access the recorded segment unless the individual provides a password or is in possession of a corresponding token that allows for decryption of the encrypted segments.

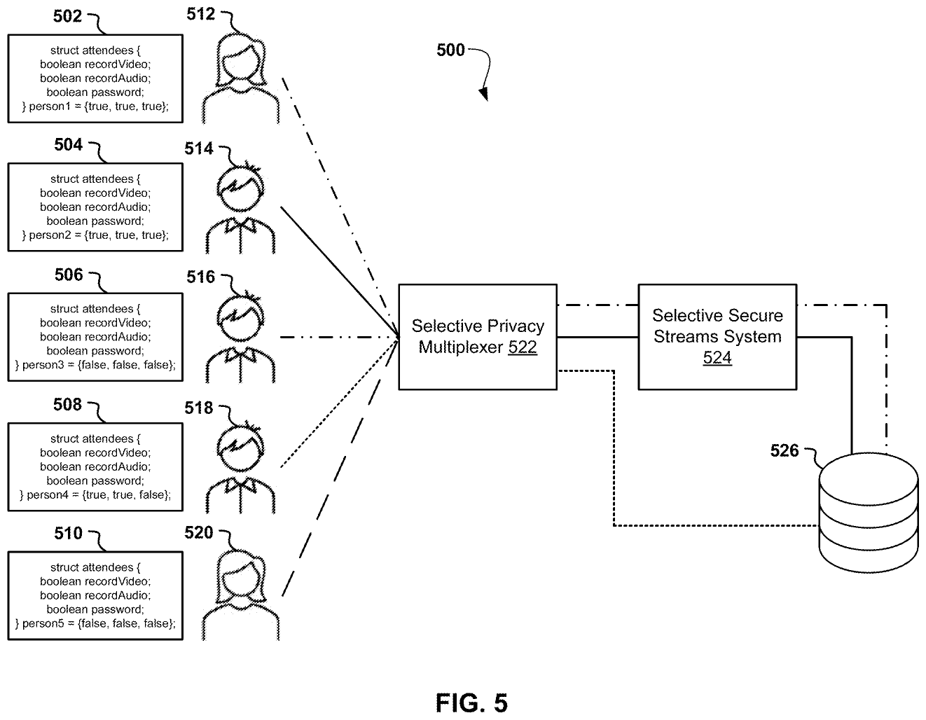

Referring now to FIG. 5, a block diagram 500 of a selective conference recording process according to at least one embodiment. During a web conference between five participants 512-520, a host participant 512 may initiate recording of the web conference. Upon identifying the desire of host participant 512 to record the web conference, the selective conference recording program 150 may display a dialog box to each web participant 512-520 to indicate their respective permission for recording each participant's respective participation and recording access permission. The selective conference recording program 150 may record the respective recording authorization and recording access permission in optional data of a TCP header. For example, optional data 502-504 for each participant 512-520 may include respective code for authorization to record video and record audio and password protection. As a more specific example, one participant 514 may authorize recording of both audio and video for their segments of the web conference as well as enable password protection of the segments in which that participant 514 speaks, presents, or interfaces with a chat. As such, the selective conference recording program 150 may write to optional data in TCP header as:

struct attendees {
boolean recordVideo;
boolean recordAudio;
boolean password;
} person 2 = {true, true, true}

Similarly, another participant 516 may deny authorization for recording either audio or video for their segments of the web conference. Since participant 516 did not authorize recording of audio or video for their respective interactions in the web conference, the selective conference recording program 150 may automatically enter “false” for the Boolean flag corresponding to recording access password permissions. As such, the selective conference recording program 150 may write to optional data in TCP header as:

struct attendees {
boolean recordVideo;
boolean recordAudio;
boolean password;
} person 3 = {false, false, false}

Once each participant has provided their responses to the dialog box, the selective conference recording program 150 may proceed with recording the web conference according to the information written to the TCP header. As such any participant that opted out of recording authorization may have their audio and video stream filtered out by a selective privacy multiplexer 522. For example, Participant A 512, Participant B 514, and Participant D 518 may allow recording of their audio and video streams as indicated through their TCP header information 502, 504, and 508. Therefore, their corresponding streams may proceed for possible encryption. However, Participant C 516 and Participant E may deny recording of their audio and video streams as indicated through their TCP header information 506 and 510. Therefore, their corresponding streams may be filtered out rather than proceeding on for possible encryption since no information requires encryption.

After the filtering of streams by selective privacy multiplexer 522, the selective conference recording program 150 may determine whether the remaining recording streams require encryption with selective secure streams system 524. If encryption is required based on the Boolean flag set in the corresponding TCP header, the selective conference recording program 150 may encrypt the stream and forward it on for storage in a repository 526. For example, Participant A 512 and Participant B 514 may opt in for encryption as indicated in their respective TCP headers 502 and 504 so their streams proceed for encryption with selective secure streams system 524. However, Participant D 518 may have opted out of encryption as indicated in their TCP header 508 so their stream bypasses encryption with selective secure streams system 524 and proceeds directly to storage in repository 526.

It may be appreciated that FIGS. 2-5 provide only an illustration of one implementation and do not imply any limitations with regard to how different embodiments may be implemented. Many modifications to the depicted environments may be made based on design and implementation requirements. For example, the selective conference recording program 150 may enable a participant to manually unauthorize recording or enable encryption of any interaction (e.g., audio, video, chat, etc.) during the web conference even if that participant already authorized recording and/or opted out of encryption for the web conference recording as a whole. For example, if a topic arises that a participant wishes to be kept confidential between the web conference participants but the participant has already authorized recording without encryption, the participant may manually interact with a GUI to indicate that the current interaction should either not be recorded or should be encrypted. The participant that initiates such manual update to recording and access permissions may either again manually update the permissions when they wish to reengage original selections or set a period of time for which recording should be paused or encryption enabled. For example, at the conclusion of the topic with which the participant wishes to be kept confidential, the participant may manually interact with the GUI to reauthorize recording or disengage encryption. Similarly, when the participant initially revokes recording authorization or engages encryption at the start of the topic, the participant may indicate a period of time (e.g., 10 minutes) for which the recording authorization is revoked and/or encryption is enabled.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
in response to an initiation of a recording of a web conference, receiving a recording authorization selection and a recording access permission selection from each participant within a plurality of participants to the web conference;
writing the recording authorization selection and the recording access permission selection to a corresponding TCP header for each participant;
recording a stream of the web conference for each participant based on the recording authorization selection;
in response to the recording ending, encrypting the stream for each participant based on the recording access permission selection; and
generating an enriched recording of the web conference based on the encrypted streams.

2. The method of claim 1, wherein the writing occurs in an optional data field of the corresponding TCP header.

3. The method of claim 1, wherein the encrypting comprises performing password protection and/or tokenization to the stream for each participant opting into the recording access permission selection.

4. The method of claim 1, wherein the enriched recording attenuates volume of each encrypted audio stream to −96 db.

5. The method of claim 1, wherein the writing sets a Boolean flag for each of a plurality of selections within the recording authorization selection and the recording access permission selection, and wherein the Boolean flag is selected from a group consisting of audio authorization, video authorization, chat interaction authorization, password protection, and tokenization.

6. The method of claim 1, wherein the recording ending for a participant is selected from a group consisting of a participant stopping the recording through a user interaction with a graphical user interface, a conclusion of the web conference, and a participant leaving the web conference before the conclusion of the web conference.

7. The method of claim 6, wherein the encrypting is performed, for each participant leaving the web conference before the conclusion of the web conference, at a time each participant leaves the web conference, and wherein encrypting is performed, for each participant present at the conclusion of the web conference, at the conclusion of the web conference.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
in response to an initiation of a recording of a web conference, receiving a recording authorization selection and a recording access permission selection from each participant within a plurality of participants to the web conference;
writing the recording authorization selection and the recording access permission selection to a corresponding TCP header for each participant;
recording a stream of the web conference for each participant based on the recording authorization selection;
in response to the recording ending, encrypting the stream for each participant based on the recording access permission selection; and
generating an enriched recording of the web conference based on the encrypted streams.

9. The computer system of claim 8, wherein the writing occurs in an optional data field of the corresponding TCP header.

10. The computer system of claim 8, wherein the encrypting comprises performing password protection and/or tokenization to the stream for each participant opting into the recording access permission selection.

11. The computer system of claim 8, wherein the enriched recording attenuates volume of each encrypted audio stream to −96 db.

12. The computer system of claim 8, wherein the writing sets a Boolean flag for each of a plurality of selections within the recording authorization selection and the recording access permission selection, and wherein the Boolean flag is selected from a group consisting of audio authorization, video authorization, chat interaction authorization, password protection, and tokenization.

13. The computer system of claim 8, wherein the recording ending for a participant is selected from a group consisting of a participant stopping the recording through a user interaction with a graphical user interface, a conclusion of the web conference, and a participant leaving the web conference before the conclusion of the web conference.

14. The computer system of claim 13, wherein the encrypting is performed, for each participant leaving the web conference before the conclusion of the web conference, at a time each participant leaves the web conference, and wherein encrypting is performed, for each participant present at the conclusion of the web conference, at the conclusion of the web conference.

15. A computer program product, the computer program product comprising:
one or more computer-readable tangible storage media and program instructions stored on at least one of the one or more tangible storage media, the program instructions executable by a processor capable of performing a method, the method comprising:
in response to an initiation of a recording of a web conference, receiving a recording authorization selection and a recording access permission selection from each participant within a plurality of participants to the web conference;
writing the recording authorization selection and the recording access permission selection to a corresponding TCP header for each participant;
recording a stream of the web conference for each participant based on the recording authorization selection;
in response to the recording ending, encrypting the stream for each participant based on the recording access permission selection; and
generating an enriched recording of the web conference based on the encrypted streams.

16. The computer program product of claim 15, wherein the writing occurs in an optional data field of the corresponding TCP header.

17. The computer program product of claim 15, wherein the encrypting comprises performing password protection and/or tokenization to the stream for each participant opting into the recording access permission selection.

18. The computer program product of claim 15, wherein the enriched recording attenuates volume of each encrypted audio stream to −96 db.

19. The computer program product of claim 15, wherein the writing sets a Boolean flag for each of a plurality of selections within the recording authorization selection and the recording access permission selection, and wherein the Boolean flag is selected from a group consisting of audio authorization, video authorization, chat interaction authorization, password protection, and tokenization.

20. The computer program product of claim 15, wherein the recording ending for a participant is selected from a group consisting of a participant stopping the recording through a user interaction with a graphical user interface, a conclusion of the web conference, and a participant leaving the web conference before the conclusion of the web conference.
